(19) United States
(12) Patent Application Publication
(10) Pub. No.: US 2026/0208164 A1
(43) Pub. Date: Jul. 23, 2026

(54) SUBSTRATE MONOLITH COMPRISING A REFORMING CATALYST

(71) Applicant: UMICORE AG & CO. KG, Hanau-Wolfgang (DE)

(72) Inventors: Andreas EICH, Gelnhausen (DE); Martin` VOTSMEIER, Weinheim (DE)

(73) Assignee: UMICORE AG & CO. KG, Hanau-Wolfgang (DE)

(21) Appl. No.: 19/140,267

(22) PCT Filed: Dec. 21, 2023
(86) PCT No.: PCT/EP2023/087168

§ 371 Date: Jun. 17, 2025

(30) Foreign Application Priority Data
Dec. 22, 2022 (DE) 102022134540.8

(51) Int. Cl. B01J 23/46; B01J 23/00; B01J 35/00; B01J 37/02; B01J 37/08; C01B 3/40; H01M 8/0612

(52) U.S. Cl. CPC B01J 23/464; B01J 23/005; B01J 35/19; B01J 37/0215; B01J 37/0236; B01J 37/088; C01B 3/40; H01M 8/0618; C01B 2203/0227; C01B 2203/107; C01B 2203/1082; C01B 2203/1241

(57) ABSTRACT

The present invention relates to a catalyst body in the form of a substrate monolith, and to a device for reforming, in particular adiabatically, hydrocarbons, in particular methane from natural gas. The catalyst body contains precious metals and a carrier oxide for the precious metals. A process for producing the catalyst and the use of said catalyst for producing hydrogen is also claimed. The precious metals are selected from platinum, palladium and rhodium, and the molar ratio M1/M2 at the inlet region of the substrate monolith is higher than at the other end, wherein M1 is Pt and/or Pd, and M2 is Rh.

The present invention relates to a catalyst body in the form of a substrate monolith, and to a device for reforming, in particular adiabatically, hydrocarbons, in particular methane from natural gas. This reforming catalyst contains precious metals and a carrier oxide for the precious metals. A process for producing the catalyst and the use of said catalyst for producing hydrogen are also claimed.

Low-emission mobility and low-emission electricity generation will play an increasingly important role in the future. One way to achieve low-emission mobility and low-emission electricity generation is to use hydrogen as an energy carrier. There are many approaches to this. One problem in this context is generating and storing hydrogen. Hydrogen is very volatile and, as the lightest chemical element, can only be liquefied or stored under extreme conditions.

Therefore, there is an increasing search for solutions for generating hydrogen where it is needed. One approach to generating hydrogen in situ is converting hydrocarbons such as natural gas via a reforming catalyst at elevated temperatures. Hydrocarbons and natural gas are comparatively easy to store and are available almost everywhere thanks to existing infrastructure. This hydrogen can then be converted into electrical current in a fuel cell, for example, which electrical current can be utilized for movement or stationary use.

Corresponding processes and catalysts for reforming are known to a person skilled in the art (e.g. WO201103338A2, WO2003104143A1, US2013079217AA, US2009283419AA, US2008219918AA, EP2251080A1). WO2005056179A1 describes catalysts for reforming hydrocarbons in order to generate hydrogen, which catalysts contain precious metals and carrier oxides. Carrier oxides based on aluminum oxide, magnesium oxide and cerium oxide, inter alia, are proposed here. The aluminum oxide is mixed, in the form of a spinel comprising magnesium, into the carrier oxide. The further addition of aluminum oxide and the addition of cerium oxide complete the composition of the carrier oxide.

Despite the number of proposals for corresponding catalysts, the problem of providing further, improved catalysts for reforming hydrocarbons still remains. These reforming catalysts should have sufficient stability and activity to be able to generate hydrogen under the most efficient conditions possible. Furthermore, a corresponding catalyst should be highly robust and durable, and be as cost-effective as possible. In particular, the significant increase in the price of rhodium requires further optimization of such catalysts inter alia with regard to their activity. Against this background, it can help to substitute rhodium for platinum, which is less active in steam reforming of, for example, methane, but which can be used more advantageously due to its significantly lower price.

These and further problems evident from the prior art are solved by a substrate monolith comprising the features of the present claim 1. Claims 2 to 6 relate to preferred embodiments of the catalyst according to the invention. Claim 7 relates to a device for generating electricity and claim 8 to a process for producing the corresponding catalysts. Claims 9-12 relate to suitable uses thereof.

By specifying a substrate monolith comprising a reforming catalyst for generating hydrogen from hydrocarbons, in particular methane, which reforming catalyst comprises precious metals and at least one carrier oxide on which the precious metals are deposited, wherein the precious metals are selected from the group consisting of Pt, Pd and Rh, and M1/M2 is larger at the inlet region of the substrate monolith than at the other end, wherein M1=Pt and/or Pd and M2=Rh, it is possible to find a very simple, but no less surprising, solution to the stated problem. M1 and M2 thereby describe the molar amounts of Pt and/or Pd as well as of Rh in the substrate monolith. These are measured, for example, once at the front in the inlet region (5 mm from the beginning of the substrate monolith in the direction of flow) and once in the outlet region (5 mm from the end of the substrate monolith against the direction of flow). The inlet region of the substrate monolith is the region that first comes into contact with the inflowing gas.

The substrate monolith according to the invention comprising a reforming catalyst presented here shows extremely advantageous activity compared to the examples of the prior art. The asymmetric distribution of the precious metals in accordance with the present invention results in a catalyst which, on the one hand, shows good activity and, on the other hand, is optimized with regard to the use of the expensive precious metals. In particular, the zoned architecture allows for a simple design of the invention in terms of production technology with regard to the distribution of the precious metals. In addition, the catalyst is very robust against changing environmental conditions and shows extraordinary long-term stability (see Tab. 2). As of the priority date, this was not to be expected.

The reforming catalyst according to the invention is surprisingly simple in structure. The reforming catalyst advantageously consists of precious metals deposited on a carrier oxide, in particular Pt and Rh or only Pt or Rh, optionally in corresponding zones or having corresponding concentration gradients. It has proven to be advantageous if the precious metals, in particular Pt and Rh, are thereby deposited together on the oxides. In this case, deposited together means that no differentiation is made with regard to the oxides to the extent that, for example, Rh is only deposited on cerium oxide and Pt is only deposited on aluminum oxide. During the joint deposition, it is possible that the alloying of the precious metals, in particular by Pt and Rh, has a beneficial effect for significant hydrogen production (CH₄+2 H₂O→4 H₂+CO₂).

All materials familiar to a person skilled in the art for this purpose, such as Al₂O₃, CeO₂, ZrO₂, TiO₂, La₂O₃, BaO, SnO₂, ZnO, MgO, HfO₂ and MnO₂, as well as their mixtures or mixed oxides, inter alia, can be considered as components of the carrier oxide in the context of the invention. Optionally doped mixed oxides (e.g. cerium-zirconium mixed oxides) can also be used in this case. Physical mixtures comprising aluminum oxide, cerium oxide and/or spinel (MgAl₂O₄; https://de.wikipedia.org/w/index.php?title=Spinell&oldid=224329096) are advantageously used in this case. The composition of the carrier oxide can vary. Aluminum oxide, cerium oxide and spinel are preferably exclusively present as the carrier oxide. Possible compositions can be obtained as desired through physical mixtures, although preferably at least all three components can be included. Further preferred mixtures are between 5 MgAl₂O₄+CeO₂+1.7 Al₂O₃ and 20 MgAl₂O₄+CeO₂+6.9 Al₂O₃. Particularly preferable is the composition 8-9 MgAl₂O₄+CeO₂+2-4 Al₂O₃. Suitable carrier oxides can also be taken from the prior art mentioned at the outset.

Particularly suitable aluminum oxides in this context are selected from the series consisting of aluminum oxide and doped aluminum oxide. Doped aluminum oxides are, for example, aluminum oxides doped using lanthanum oxide, zirconium oxide, silicon oxide, cerium oxide, barium oxide and/or titanium oxide. Aluminum oxide, La-doped aluminum oxide or Cer-doped aluminum oxide is advantageously used, lanthanum being used in quantities in particular of 1 to 10 wt. %, preferably 3 to 6 wt. %, in each case calculated as La₂O₃ and based on the weight of the stabilized aluminum oxide. Also in the case of aluminum oxide doped using barium oxide, the proportion of barium oxide is in particular 1 to 10 wt. %, preferably 3 to 6 wt. %, in each case calculated as BaO and based on the weight of the stabilized aluminum oxide. A particularly suitable aluminum oxide is lanthanum-stabilized aluminum oxide, which is optionally additionally doped using cerium oxide, barium oxide and/or strontium oxide. The carrier oxide preferably comprises at least one aluminum oxide or doped aluminum oxide. Particularly preferable in this context is in particular γ-aluminum oxide or La-stabilized γ-aluminum oxide having a BET surface area of 30 to 250 m²/g, preferably 100 to 200 m²/g (determined according to DIN 66132, latest version on the date of filing). Such active aluminum oxide is widely described in the literature and, as mentioned, can be obtained on the market (e.g. from the company Sasol®). Most preferable is an aluminum oxide or a doped aluminum oxide which has a particle size distribution of d50 value of <100 μm, preferably <70 μm and most preferably <50 μm (Q3 distribution, ISO 13320-1, latest version on the date of filing).

The carrier oxide preferably comprises at least one high-surface-area and temperature-stable cerium oxide (e.g. EP1435338A1), which can also be obtained commercially (e.g. from the company Solvay®). Cerium oxide is used in the carrier oxide in amounts of 1 to 20 wt. %, preferably 8 to 12 wt. %.

The carrier oxide preferably has at least one MgAl₂O₄ type spinel as a third component. The spinel is particularly preferably used as the main component in the carrier oxide in amounts of 50 to 90 wt. %, preferably 60 to 80 wt. %. This can be produced in-house (e.g. DE1571299B2; https://de.wikipedia.org/w/index.php?title=Spinelle&oldid=225306698) or can also be obtained commercially. The remainder of the carrier oxide is then preferably only the above aluminum oxide.

It is of particular advantage that the present reforming catalyst comprises only the components just mentioned. In particular, it does not require any additional transition metals or transition metal oxides. The present catalyst advantageously does not comprise elements selected from the group consisting of zirconium, chromium and nickel.

The reforming catalyst is usually present as a normal coating on the substrate monolith. In this regard, the embodiment in which the reforming catalyst according to the invention comprises additional binders is therefore advantageous. For example, active temperature-stable metal oxides which have little or no catalytic activity, such as SiO₂, Al₂O₃ and ZrO₂, are suitable as binding agents. A person skilled in the art is aware of the materials that can be used here. The proportion of such binders in the reforming catalyst can, for example, amount to up to 10 wt. %, preferably up to 5 wt. %, of the entire mass of the reforming catalyst. Binding agents are suitable for ensuring stronger adhesion of the coating to a carrier. For this purpose, a certain particle size of the metal oxides in the binding agent is advantageous. This can be adjusted accordingly to individual requirements by a person skilled in the art. Adding, for example, sols of the elements mentioned above to the coating suspension has proven to be advantageous. Particularly advantageous in this context is an aluminum sol such as Nyacol® or boehmite (https://de.wikipedia.org/w/index.php?title=B % C3% B6hmit&oldid=226104395).

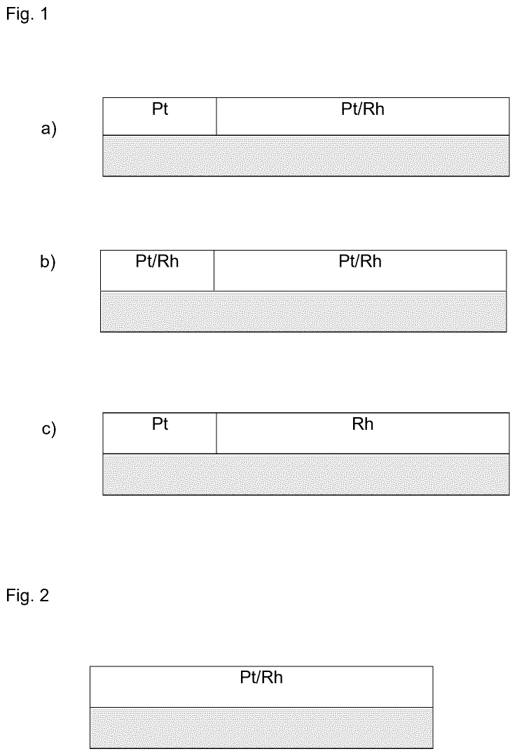

The reforming catalyst comprises precious metals, in particular Pt and Rh, deposited on a carrier oxide. Preferably only Pt and Rh are used. The molar ratio of Pt to Rh in the substrate monolith is hereby preferably 1:2 to 8:1, more preferably 1:1 to 5:1 and most preferably 2:1 to 3:1. It may also be that no Pt and only Rh, or Pt and no Rh is present in corresponding zones (e.g. FIG. 1c).

In the present case, according to the invention, the ratio M1/M2 varies over the length of the substrate monolith. Pt and/or Pd are in any case present at the front (5 mm from the inlet into the substrate monolith). A zone is particularly preferably located in the inlet region of the substrate monolith, which zone in particular comprises Pt and has a higher M1/M2 ratio than a zone positioned in the outlet region of the substrate monolith. The inlet region of the substrate monolith thereby comes into contact with the inflowing gas first. The reforming reaction occurring throughout the entire substrate monolith is significantly endothermic. This results in the temperature in the outlet region being significantly lower than in the inlet region. The substrate monolith must therefore be able to withstand a large temperature gradient that is typical for it.

For this purpose, advantageous values for M1/M2 for the front (5 mm from the inlet of the substrate monolith) and the rear (5 mm from the end of the substrate monolith) are given in the following Table 1:

TABLE 1

| Values M1/M2 | Front | Rear |
|---|---|---|
| Preferred | 1-∞ | 1-0.01 |
| More preferred | 100-∞ | 1-0.1 |
| Most preferred | ∞ | 1-0.5 |

The present invention relates to a substrate monolith comprising a reforming catalyst. The reforming catalyst can be applied, by means of a coating step familiar to a person skilled in the art, to a substrate monolith, preferably to a flow-through substrate (DE102019100099A1 and literature cited therein). A filter substrate such as a wall-flow filter is also possible in this context. Flow-through substrates are substrate monoliths that are common in the prior art, which can consist of metal (for example WO17153239A1, WO16057285A1, WO15121910A1 and literature cited therein) or of ceramic materials. ‘Corrugated substrates’ can also be regarded as flow-through substrates. These are known to a person skilled in the art as carriers made of corrugated sheets consisting of inert materials. Suitable inert materials are, for example, fibrous materials having an average fiber diameter of 50 to 250 μm and an average fiber length of 2 to 30 mm. Fibrous, heat-resistant materials made of silicon dioxide, in particular glass fibers, are preferred. However, refractory ceramics, such as cordierite, silicon carbide or aluminum titanate, etc., are preferably used as honeycomb carriers. The number of channels of these carriers per surface area is characterized by the cell density, which typically ranges between 300 and 900 cells per square inch (cpsi). The wall thickness of the channel walls in ceramics is between 0.5-0.05 mm.

The absolute length of the substrate monoliths according to the invention comprising the reforming catalysts can also be adjusted by a person skilled in the art and adapted to individual needs. A length of 5.0-16.0 cm, preferably 6.0-14.0 cm and most preferably 7.0-13.0 cm has proven to be advantageous for the present intended use.

The total amount of coatings in the substrate monolith is selected such that the catalyst according to the invention is utilized as efficiently as possible overall. In the case of a flow-through substrate, the total amount of the reforming catalyst in the coatings (proportion of solids) per carrier volume (total volume of the carrier) can, for example, be between 100 and 300 g/L, in particular between 120 and 250 g/L. The total precious metal content of the substrate monolith is preferably from 0.015-5 g/L, more preferably from 1.0-3.0 g/L, and particularly preferably from 1.6-2.2 g/L carrier volume. If platinum or palladium is used, it should be in the range of 0.5-2.5 g/L, more preferably 1.3-1.9 g/L carrier volume in the coating. Rhodium is present in the reforming catalyst in an amount of 0.1-1.0 g/L, more preferably 0.3-0.4 g/L carrier volume in the relevant component.

In a further preferred embodiment, the substrate monolith discussed here has a particularly advantageous design for the present intended use. In this case, a zoned design is particularly suitable. A zoned design is preferable, as shown by way of example in FIG. 1. The substrate monolith is particularly preferably constructed in such a way that it has, on the upstream side, a coating zone comprising Pt on the carrier oxide, and, on the downstream side, a coating zone comprising a metal mixture comprising Pt and Rh on the carrier oxide. It may also be advantageous if the two zones contain Pt and Rh, with the front zone containing a higher concentration of Pt and the rear zone containing a higher concentration of Rh. If Pt and Rh occur together in one zone or together in the entire substrate monolith in the context of the invention (e.g. FIG. 2), it is surprisingly advantageous to mix them before introducing them into the washcoat, for methane reforming which is as efficient as possible. A person skilled in the art knows how to proceed in this regard. It is also possible to locate the zones on different flow-through substrates connected directly one after the other. Upstream means that this zone initially comes into contact with the medium to be converted, before the other zone is brought into contact. Downstream is to be understood accordingly.

The corresponding coating on the substrate monolith is used in an amount of 15 to 200 g/L, in particular between 100 and 200 g/L, particularly preferably of approximately 120-180 g/L total carrier volume. In this case, the total precious metal content can be in the range of 0.01-3.0 g/L, more preferably 1.65-2.15 g/L total carrier volume in the coating. Rh is advantageously contained in the corresponding zone(s) in amounts of preferably 0.07-0.5 g/L, in particular 0.1-0.35 g/L. The platinum content in the corresponding zone(s) is preferably also 0.07-2.0 g/L, more preferably 0.5-1.3 g/L total carrier volume.

Depending on the gas composition and temperature profile of the catalyst, Pt may be present in the downstream zone in addition to Rh. The Pt/Rh zone preferably contains Pt: Rh in a molar ratio of 1:1, but can have other ratios of 3:1-1:2, depending on the gas composition and temperature profile of the catalyst. It may also be advantageous to use only rhodium as the precious metal in this zone.

As already indicated, the preferred zones are located on a substrate monolith. It is also possible that the preferred zones are located on two substrate monoliths, which are then arranged directly one after the other. The zone lengths can be selected by a person skilled in the art. It has proven to be advantageous if the upstream zone in the reforming catalyst according to the invention is shorter than the downstream zone due to the significant temperature drop in the catalyst. The ratio of the zone lengths is preferably between 50/50-30/70 and more preferably around 40/60-30/70.

The present invention also relates to a device for generating electricity, comprising a substrate monolith as just outlined and a fuel cell in fluid contact therewith. Such devices and their design are known in principle to a person skilled in the art (e.g. JP2008007359 (A), CN111029628). The hydrogen produced via the reforming catalyst according to the invention on the substrate monolith is brought into contact with the anode of the fuel cell via a fluid connection. The hydrogen is then converted into hydrogen ions, which oxidize with atmospheric oxygen at the cathode to form H₂O which can be released into the ambient air.

The present invention further relates to a process for producing a corresponding reforming catalyst substrate, in which process the substrate monolith is coated using a coating suspension comprising the components of the reforming catalyst according to the invention in water, subsequently dried and calcined and finally tempered at a temperature of 500-600° C. for a maximum of 2 hours.

In a first step, a coating suspension is preferably produced from the carrier oxide components and optionally binding agents in water. This suspension is then mixed with solutions of water-soluble precious metal compounds, in particular Rh compounds and optionally Pt compounds. The precious metals are thus preferably deposited together onto the entire carrier oxide by mixing and subsequent injection. Separately producing the oxides provided with precious metals and the subsequent mixing thereof is also possible. Producing corresponding suspensions for coating substrates is well known to a person skilled in the art from the field of producing automotive exhaust gas catalysts (e.g. DE202016008848A1).

This suspension is subsequently applied to a substrate monolith, in particular a flow-through substrate. These procedures are also familiar to a person skilled in the art, for example from the field of automotive exhaust gas catalysts (e.g. WO2020141188A1 and literature cited therein). The zones can be coated using methods familiar to a person skilled in the art (e.g. EP1273344A1, EP2533901A1). The coated substrate monolith is then optionally dried and calcined. It has proven to be advantageous if the coated substrate monolith is finally tempered at a slightly higher temperature in order to completely remove organic components of the coating in the form of, for example, CO₂ or NOₓ. This also makes it possible to establish a mass balance on an oxide basis.

It is particularly advantageous if the coated substrate monolith is dried at 100-150° C., preferably 110-130° C. The calcination temperature should not be too high. It is preferably between 300° C. and a maximum of 500° C., preferably between 320° C. and 400° C. The catalyst is subsequently tempered for preferably a maximum of 6 hours, more preferably a maximum of 4 hours and particularly preferably for up to 3 or 2 hours at a temperature of 400-600° C., preferably 520-580° C. The reforming catalyst on the substrate monolith is subsequently ready for insertion into the device according to the invention.

The present invention also relates to the use of a substrate monolith according to the invention, comprising a reforming catalyst for generating hydrogen from hydrocarbons, in particular methane. Methane is the most stable hydrocarbon. It is comparatively difficult to convert using a catalyst. However, it is the main component of natural gas. The reforming catalyst according to the invention is capable of converting methane in a sufficient manner. The conversion hereby preferably takes place adiabatically at temperatures of 300-900° C., preferably 650-800° C. in an atmosphere preferably consisting of methane, water vapor and, through possible exhaust gas recirculation, additionally CO, CO₂ and H₂. A preferred use is one in which the hydrogen is produced from natural gas (CNG, LNG).

The substrate monolith according to the invention is used for reforming hydrocarbons. It generates a surprisingly large amount of hydrogen when converting hydrocarbons, in particular methane, at elevated temperatures. Since the reactions taking place have an endothermic character, it is advantageous to minimize heat loss to the environment through insulation as much as possible in order to keep heat dissipation as low as possible. It is therefore advantageous during the use according to the invention if this use takes place under adiabatic conditions, i.e. there is little to no heat exchange in both directions, to or from the environment. The use should preferably be designed such that the heat exchange with the environment is between zero and 15%, preferably less than 10% and most preferably less than 5% based on the amount of heat supplied in the form of the heated reaction gases via the substrate monolith. A person skilled in the art knows how to insulate the substrate monolith from the environment in order to achieve these values.

In a further preferred use, the hydrogen thus generated is used for generating electricity in a fuel cell. Further preferred uses according to the invention can be found both in the mobile sector (vehicles) and in the stationary sector (industrial plants).

By coating, for example, a flow-through substrate consisting of cordierite using a Rh-containing and Pt- and/or Pd-containing coating medium on the corresponding carrier oxides and subsequent thermal treatment, a reforming catalyst substrate is produced which generates hydrogen from hydrocarbons, in particular methane, in an oxygen-free reaction atmosphere comprising a high water content and at elevated temperatures. Particularly active in this case is the arrangement in which the precious metals are selected from the group consisting of Pt, Pd and Rh and M1/M2 at the inlet of the catalyst is larger than at the outlet, where M1=Pt and/or Pd and M2=Rh. This achieves an optimal balance between sufficient activity and the lowest possible precious metal price.

The reforming catalyst is long-term stable and, even with intended continuous use of over 50,000 hours and in very harsh conditions, is still sufficiently active to generate hydrogen, even towards the end of its service life. Due to the endothermic reaction, there is thereby a very strong temperature gradient within the reforming catalyst, which temperature gradient can be up to 200° C. at the desired application parameters. The reforming catalyst according to the invention manages to meet these requirements.

The figures show:

FIG. 1: Preferred layout of the reforming catalyst according to the invention, the reforming catalyst comprising the individual zones.

FIG. 2: Further conceivable embodiments of the reforming catalyst according to the invention: mixture of Pt and Rh over the entire substrate monolith, wherein the M1/M2 ratio is varied according to the invention.

### EXAMPLES

In order to produce the catalysts, cordierite substrates from NGK (4.66″×4.66″×5.00″, 4.3/300) are coated using a washcoat. Other flow-through substrates which in particular have different cell densities and wall thicknesses and are also made of cordierite (e.g. 5.66″×5.66″×5.00″, 4/400) are also possible. Metal substrates can also be used. The catalytic activity is not substrate-dependent.

In order to produce the washcoat, the carrier oxide (Puralox® SCFa 110 from Sasol) and the AlO(OH) binder (Nyacol® AL20 from Nyacol) are first dispersed in water, one after the other. The precious metal solutions are subsequently injected. For the zones of the catalysts containing the two precious metals, the platinum nitrate and rhodium nitrate solutions are mixed and diluted with water before injection. After 30 min of stirring, the pH value is adjusted to >7 and the washcoat is ground in a circle. The target particle size distribution has a d50 value of 4.5-5.5 μm and a doo value of 10.6-14.8 μm.

Depending on the oxide-based solids content, which is ideally 33-36%, and on the rheology of the washcoat, it can be adjusted using nitric acid (HNO₃), tetraethylammonium hydroxide (TEAH) or acetic acid (HCOOH) for easier coatability.

Finally, the substrate is clamped vertically in a holding device, and the washcoat is pumped from below into the substrate to the desired height and subsequently sucked out again. By weighing after a drying and calcining step, any remaining mass is determined and optionally re-coated.

In an alternative coating process, the washcoat is applied to the vertically aligned substrate. By applying negative pressure, the washcoat is subsequently sucked through the substrate. By weighing after a drying and calcining step, any remaining mass is determined and re-coated from the other side. In addition to this coating process, the required washcoat can also be determined before coating and, in halves corresponding to the optionally present zones, can be sucked into the substrate from both sides in two steps.

The last step is the thermal treatment of the catalyst. After drying at 100-120° C. and calcining at 350° C. for approx. 15 minutes each after each coating step, tempering takes place at 550° C. for 2 hours.

The following substrate monoliths were produced:
Example 1-Inlet: 18.48 g/ft³ Pt (1:0) Outlet: 18.52 g/ft³ Pt, 9.77 g/ft³ (1:1)
Example 2-Inlet: 23.74 g/ft³ Pt, 2.77 g/ft³ Rh (4.52:1) Outlet: 13.26 g/ft³ Pt, 7.0 g/ft³ Rh (1:1)
Example 3-Inlet: 2.0 g/ft³ Pt, 5.0 g/ft³ Rh (0.21:1) Outlet: 35 g/ft³ Pt, 4.77 g/ft³ Rh (3.87:1)
Example 4-Homogeneously coated: 37 g/ft³ Pt, 9.77 g/ft³ Rh (2:1)

All zoned examples are zoned 30/70.

For testing, 1″×3″ drill cores are taken from the coated catalyst and their methane conversion is tested in an adiabatic quartz glass reactor.

The main reaction gas mixture tested consists of 5.9% CH₄, 21.9% H₂O, 1.8% CO, 12.9% CO₂, 7.5% H₂ and N₂ to balance at a space velocity of 25,000 1/h. The measurement starts at 150° C. gas temperature. Heating takes place at 10 K/min up to 700° C. When this maximum temperature is reached, the temperature is kept constant for another 30 minutes, after which the measurement ends. Finally, the mixture is cooled to 450° C. in the reaction gas atmosphere, and then to room temperature in air.

The methane conversion, which is a measure of the activity of the catalyst, is calculated from the methane input concentration before methane conversion and the concentration at maximum reactor temperature.

In addition to testing fresh catalysts, it is necessary to simulate catalyst aging in order to be able to evaluate long-term stability and long-term activity. For this purpose, the catalyst drill cores produced were aged for approximately 50 hours at 850° C. in a permeating atmosphere of forming gas (3.3% H₂, N₂) and 44% H₂O. The decrease in catalytic activity after aging is a measure of the long-term stability and long-term activity of the catalysts.

Measurement results (Table 2: Tested catalysts where Pt:Rh = 2:1)

| | | Methane | Molar | |
|---|---|---|---|---|
| Catalyst name/ | M1/M2 | conversion at | Pt:Rh | |
| parameter | front rear* | T_{In} = 700° C./% | ratio | Architecture |
| Example 1 | ∞-1 | 27.12 | 2:1 | According to |
| fresh | | | | FIG. 1. a) |
| Example 1 | | 24.28 | | |
| aged | | | | |
| Example 2 | 4.52-1 | 25.35 | 2:1 | According to |
| fresh | | | | FIG. 1. b) |
| Example 2 | | 22.96 | | |
| aged | | | | |
| Example 3** | 0.21-3.87 | 24.67 | 2:1 | According to |
| fresh | | | | FIG. 1. b) |
| Example 3** | | 22.86 | | |
| aged | | | | |
| Example 4** | 2-2 | 23.77 | 2:1 | According to |
| fresh | | | | FIG. 2 |
| Example 4** | | 23.08 | | |
| aged | | | | |

*front is 5 mm from the inlet of the substrate monolith; rear is 5 mm from the end of the substrate monolith;
**Reference examples

As can be seen in the table above, the architecture according to FIG. 1a) having a Pt: Rh ratio of 2:1 results in the highest methane conversion before and after aging (example 1). In general, methane conversion increases as the platinum content in the input region increases. The methane conversion, which appears low at first glance, is due to the fact that only small drill cores and no full catalysts were tested, but the amount of reaction gases corresponded to about half of the amount of gas intended to be passed through a full catalyst.

1. Substrate monolith comprising a reforming catalyst for generating hydrogen from hydrocarbons, in particular methane, which reforming catalyst comprises precious metals and at least one carrier oxide on which the precious metals are deposited,
characterized in that the precious metals are selected from the group consisting of Pt, Pd and Rh, and M1/M2 is larger at the inlet region of the substrate monolith than at the other end, wherein M1=Pt and/or Pd, and M2=Rh.

2. Substrate monolith according to claim 1, characterized in that the carrier oxide comprises a MgAl₂O₄ spinel and CeO₂ and Al₂O₃.

3. Substrate monolith according to claim 1, characterized in that it does not contain any elements selected from the group consisting of zirconium, chromium and nickel.

4. Substrate monolith according to claim 1, characterized in that it comprises a binder.

5. Substrate monolith according to claim 1, characterized in that the molar ratio of Pt to Rh is 1:2 to 8:1.

6. Substrate monolith according to claim 5, characterized in that it comprises at least 2 zones, and the two zones contain Pt and Rh, and the front zone contains a higher concentration of Pt and the rear zone contains a higher concentration of Rh.

7. Device for generating electricity, comprising a substrate monolith according to claim 1 and a fuel cell in fluidic contact therewith.

8. Process for producing a substrate monolith of claim 1, characterized in that the substrate monolith is coated using a coating suspension comprising the components of the reforming catalyst in water, subsequently dried and/or calcined, and finally tempered at a temperature of 400-600° C. for max. 6 hours.

9. Use of a substrate monolith according to claim 1 for generating hydrogen from hydrocarbons.

10. Use according to claim 9, characterized in that the use takes place under adiabatic conditions.

11. Use of a catalyst according to claim 9, characterized in that the hydrogen is produced from natural gas (CNG, LNG).

12. Use according to claim 9, characterized in that the hydrogen generated is used for generating electricity in a fuel cell.
